(19) United States
(12) Patent Application Publication
(10) Pub. No.: US 2015/0006815 A1
(43) Pub. Date: Jan. 1, 2015

(54) BACKUP OF CACHED DIRTY DATA DURING POWER OUTAGES

(71) Applicant: LSI Corporation, San Jose, CA (US)

(72) Inventors: Naresh Madhusudana, Bangalore (IN); Naveen Krishnamurthy, Bangalore (IN)

(73) Assignee: LSI Corporation, San Jose, CA (US)

(21) Appl. No.: 13/971,559

(22) Filed: Aug. 20, 2013

(30) Foreign Application Priority Data
Jun. 28, 2013 (IN) 2879CHE2013

(51) Int. Cl. G06F 12/08

(52) U.S. Cl. CPC G06F 12/0866
USPC 711/114; 711/118

(57) ABSTRACT

Systems and methods presented herein provide for backing up cached dirty data during power outages. In one embodiment, a system includes a controller operable to process input/output requests from a host system, and a cache memory operable to cache dirty data pertaining to the input/output requests. The system also includes a nonvolatile memory operable to back up the dirty data during a power outage. The controller comprises a hardware register operable to map directly to the cache memory to track the dirty data. The controller is further operable to detect the power outage, and, based on the detected power outage, to direct the hardware register to perform a direct memory access (DMA) of the dirty data in the cache memory according to the mapping between the hardware register and the cache memory, and to write the dirty data to the nonvolatile memory.

### CROSS REFERENCE TO RELATED APPLICATIONS

This document claims priority to Indian Patent Application Number 2879/CHE/2013filed on Jun. 28, 2013 (entitled BACKUP OF CACHED DIRTY DATA DURING POWER OUTAGES) which is hereby incorporated by reference

### FIELD OF THE INVENTION

The invention generally relates to the caching of dirty data during power outages.

### BACKGROUND

Dirty data is information pertaining to write input/output (I/O) operations of a host system that are written to volatile cache memory prior to transport to more permanent data storage devices (e.g., disk drives), in what is known as write-back caching. When a power outage occurs, the dirty data in the cache memory can be lost. Nonvolatile backup storage, such as flash memory devices, can be used to backup the dirty data in the event of a power outage. But, the dirty data needs to be written to the nonvolatile backup storage carefully and quickly to prevent wear of the backup storage, to prevent loss of data, and to reduce power consumption.

### SUMMARY

Systems and methods presented herein provide for backing up cached dirty data during power outages. In one embodiment, a system includes a controller operable to process I/O requests from a host system, and a cache memory operable to cache dirty data pertaining to the input/output requests. The system also includes a nonvolatile memory operable to back up the dirty data during a power outage. The controller comprises a hardware register operable to map directly to the cache memory to track the dirty data. The controller is further operable to detect the power outage, and, based on the detected power outage, to direct the hardware register to perform a direct memory access (DMA) of the dirty data in the cache memory according to the mapping between the hardware register and the cache memory, and to write the dirty data to the nonvolatile memory.

The various embodiments disclosed herein may be implemented in a variety of ways as a matter of design choice. Other exemplary embodiments are described below.

### BRIEF DESCRIPTION OF THE FIGURES

Some embodiments of the present invention are now described, by way of example only, and with reference to the accompanying drawings. The same reference number represents the same element or the same type of element on all drawings.

FIG. 1 is a block diagram of a storage system employing an exemplary storage controller to store data in a plurality of storage volumes.

FIG. 2 is a flowchart of an exemplary process of the storage controller of FIG. 1.

FIGS. 3-6 are block diagrams of data transfers between volatile cache memory, hardware registers of the storage controller, and nonvolatile backup memory.

### DETAILED DESCRIPTION OF THE FIGURES

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention and are to be construed as being without limitation to such specifically recited examples and conditions. As a result, the invention is not limited to the specific embodiments or examples described below.

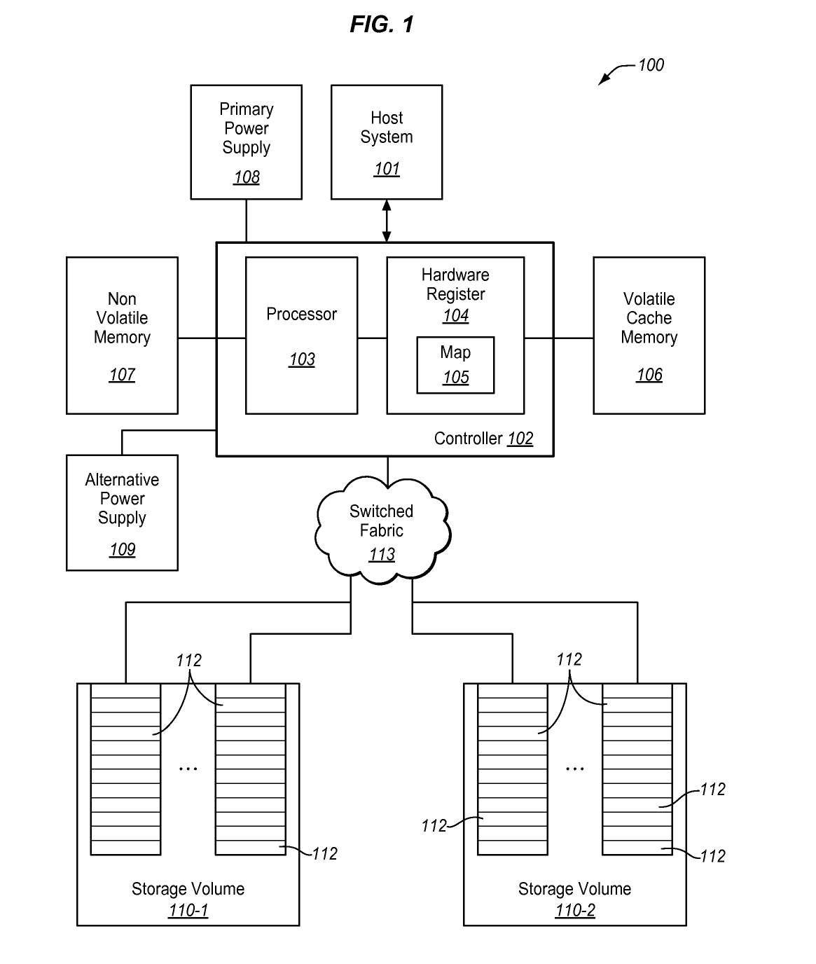

FIG. 1 is a block diagram of a storage system 100 employing an exemplary storage controller 102 to store data at various locations 112 in a plurality of storage volumes 110-1-110-2. The storage system 100 includes a host system 101 that is operable to read from and write to the storage volumes 110-1 and 110-2 via I/O operations processed through the storage controller 102. In doing so, the storage controller 102 caches write I/O requests in the volatile cache memory 106 until the data of the write requests can be written to their designated locations 112 within the storage volumes 110. For example, the cache memory 106 may be used to temporarily store user data of the host system 101 as part of a write-back operation of the storage controller 102. The caching of data of the write I/O operations improves I/O performance of the storage controller 102 because the I/Os can be completed from the cache memory 106 when the storage controller 102 deems it necessary. This user data of the write I/O operations is called “dirty data” because it has not been processed to a storage volume 110 yet. The cache memory 106 can also serve as a read cache for read I/O requests from the host system 101.

Generally, the storage controller 102 includes firmware that maintains thresholds for accumulating dirty data in the cache memory 106. When the threshold is reached, the dirty data in the cache memory 106 is flushed to the storage volumes 110-1-110-2. However, since the cache memory 106 is volatile memory, a power outage can cause the cached dirty data to be lost. To ensure that the dirty data is not lost, the storage system 100 is also configured with a nonvolatile memory 107 that is operable to provide a storage backup (e.g., a flash memory device such as a solid state storage device, or “SSD”) of the volatile cache memory 106. When a processor 103 of the storage controller 102 detects a power outage in the primary power supply 108, the processor 103 directs the volatile cache memory 106 to transfer the dirty data to the nonvolatile memory 107. The processor 103 may alternatively or additionally perform this transfer when it detects the presence of an alternative power supply 109.

Previously, all of the data in the volatile cache memory 106 was transferred to the nonvolatile memory 107 during a power outage causing unnecessary wear to the nonvolatile memory 107. For example, only the dirty data needs to be written to the nonvolatile memory 107 because that data does not reside anywhere else within the storage system 100 (i.e., within the controller 102, the storage volumes 110, etc.). Only the remaining data in the volatile cache memory 106 (a.k.a., the clean data) exists in the storage system 100. But, since the clean data already exists, there is no need to duplicate that effort within the nonvolatile memory 107. Writing both the clean data and the dirty data to the nonvolatile memory 107 wears down the nonvolatile memory 107 more quickly than simply writing just the dirty data.

Moreover, writing both the clean data and the dirty data results in more power consumption by the controller 102. For example, the volatile cache memory 106 may be a double data rate nonvolatile memory (DDR) with many gigabytes of storage space. The dirty data typically represents 50% to 60% of the storage space in the volatile cache memory 106. The DDR memory consumes substantially more power when it is forced to transfer all of its data when only half of it may be necessary.

The storage controller 102, to advantageously reduce power consumption and reduce wear on the nonvolatile memory 107, includes a hardware register 104 that is operable to perform DMAs on the volatile cache memory 106 to transfer the dirty data to the nonvolatile memory 107, leaving substantially all of the clean data (or other data) on the volatile cache memory 106. The hardware register 104 includes a map 105 that directly links to the storage locations 112 of the dirty data in the volatile cache memory 106. Because the hardware register 104 is configured within the controller 102 and directly mapped to the cache memory 106, the hardware register 104 is able to track or otherwise quickly identify the dirty data in the cache memory 106. Thus, when the power outage occurs, the hardware register 104 can DMA the dirty data and write it to the nonvolatile memory 107 much faster than traditional storage controllers.

Moreover, the hardware register 104 may be interrupt driven written to perform the DMA of the volatile cache memory 106. For example, an outage in the primary power supply 108 may result in a priority interrupt request (IRQ) that triggers the hardware register 104 to DMA the dirty data from the cache memory 106 directly to the nonvolatile memory 107. Traditional storage controllers algorithmically transfer data from volatile cache memories to nonvolatile storage backups using software. When megabytes and gigabytes of data are being processed in this manner, the processor of the storage controller would consume many clock cycles in this computationally intensive process. In doing so, the processor would consume even more power (e.g., power from the alternative power supply 109 that can be used elsewhere during a power outage of the primary power supply 108). Because the hardware register 104 of the storage controller 102 is interrupt driven, the data being transferred from the cache memory 106 can be performed in a DMA that uses a fraction of the clock cycles (e.g., one or two clock cycles) when compared to traditional storage controllers.

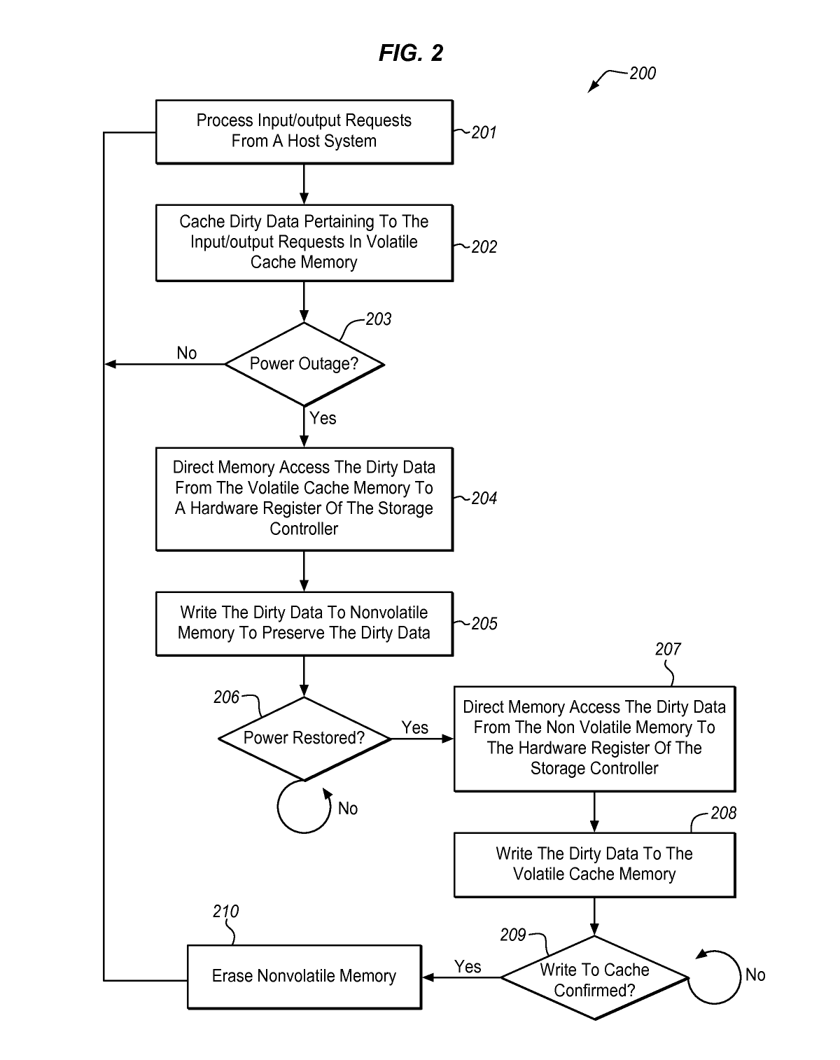

In one embodiment, the storage controller 102 is a Redundant Array of Independent Disks (RAID) controller operable to process I/O requests on behalf of the host system 101 to a plurality of storage volumes 110 through a network of storage components that provide a “switched fabric” 113. One example of such a storage controller 102 is a Mega RAID storage controller. An example of a switched fabric 113 includes a network of storage expanders such as those employing the Serial Attached Small Computer System Interface (SAS). Additional details regarding the caching and backup of the dirty data are now discussed with respect to the flowchart of FIG. 2.

FIG. 2 is a flowchart of an exemplary process 200 of the storage controller 102 of FIG. 1. The process 200 initiates with the assumption that the storage system 100 is in normal operations and that the controller 102 is processing I/O requests from the host system 101, in the process element 201. In these normal operations, the storage controller 102 is operating in a write-back cache mode for improved I/O performance. Thus, the storage controller 102 may cache certain write I/O requests until they can be written to the appropriate storage volumes 110, thereby caching “dirty data” in the volatile cache memory 106, in the process element 202.

At some time during normal I/O operations of storage controller 102, the storage controller 102 detects a power outage of the primary power supply 108 and/or application of the alternative power supply 109, in the process element 203. For example, the primary power supply 108 and/or the alternative power supply 109 may be coupled to the storage controller 102 such that the processor 103 of the storage controller 102 may be interrupted with an IRQ in the event of a power outage. Thus, when the power outage occurs, the processor 103 may direct the hardware register 104 to DMA the dirty data from the volatile cache memory 106, in the process element 204.

Each location in the hardware register 104 may be directly mapped to an address of the dirty data in the cache memory 106 such that the hardware register 104 may DMA the dirty data directly to the hardware register 104. The processor 103, when caching the write I/O operations to the cache memory 106, may flag the dirty data (and any other data deemed necessary for saving by the processor 103). The hardware register 104, being mapped directly to the addresses of the cache memory 106, can then access the cache memory 106 addresses and perform a DMA on the cache memory 106 of the dirty data based on the flag.

The processor 103 may then direct the hardware register 104 to write the dirty data to the nonvolatile memory 107, in the process element 205, to preserve the dirty data. That is, a power failure will cause the volatile cache memory 106 to lose its data. Upon indication of a power failure and/or application of alternative power, the hardware register 104 can DMA the dirty data from the cache memory 106 and write it to the nonvolatile memory 107, in the process element 205, to ensure that the dirty data is not lost. Even if alternative power is being supplied by the alternative power supply 109, the storage controller 102 may suspend I/O operations until the primary power supply 108 can be restored. This ensures that the dirty data is preserved because the nonvolatile memory 107 retains the dirty data even if the alternative power supply 109 fails.

Once power is restored, the controller 102 performs a DMA of the dirty data from the nonvolatile memory 107 to the hardware register 104 of the storage controller 102, in the process element 207. Thereafter, the storage controller 102 writes the dirty data from the hardware register 104 back to the cache memory 106 based on the map 105, in the process element 208. To ensure integrity of the dirty data, the processor 103 waits for confirmation (e.g., an acknowledgment, or “ACK”) until all of the dirty data has been written to the cache memory 106, in the process element 209. After the processor 103 receives confirmation that the dirty data has been written back to the cache memory 106, the processor 103 may erase the nonvolatile memory 107, in the process element 210, such that the nonvolatile memory 107 may once again be available for writing in the event of a subsequent power outage. Then, the storage controller 102 resumes normal write-back I/O operations in the process element 201, by processing the write I/Os cached in the cache memory 106 as well as subsequent I/Os from the host system 101.

In one embodiment, the processor 103 is operable to continue power from the alternative power supply 109 to just the hardware register 104, essentially shutting down power to other hardware components of the controller 102. Such may be used to automate the offload of dirty data via the hardware register 104 to further conserve power. For example, once the alternative power supply 109 initiates, the processor 103 may automatically trigger the transfer of the dirty data to the non-volatile memory. But, the processor 103 may shut down other components as they are not necessary to the data transfer. Thus, less power from the alternative power supply 109 is used by the controller 102 during a power outage.

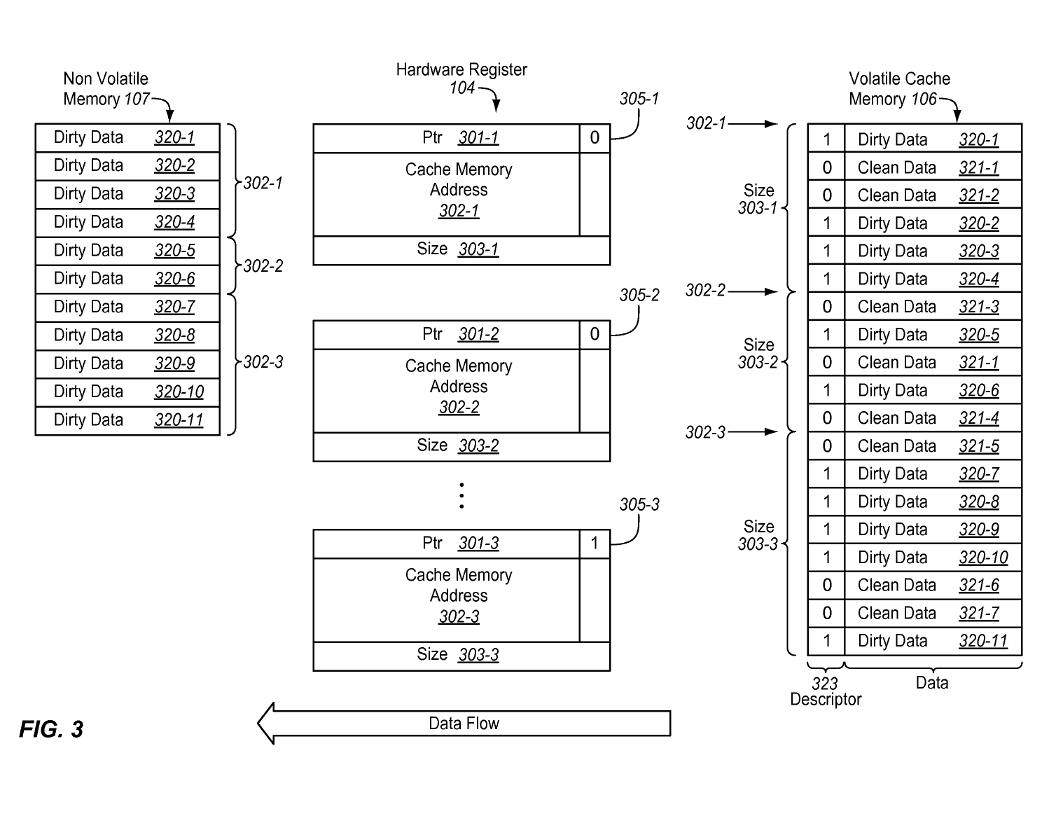

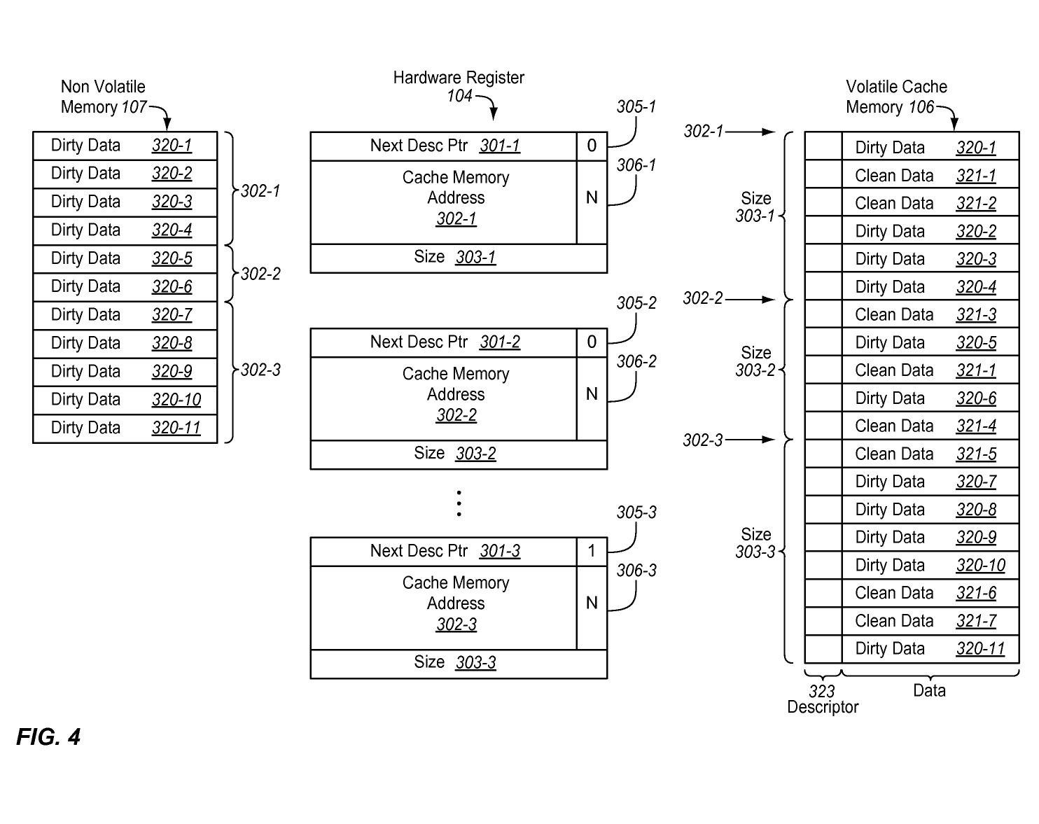

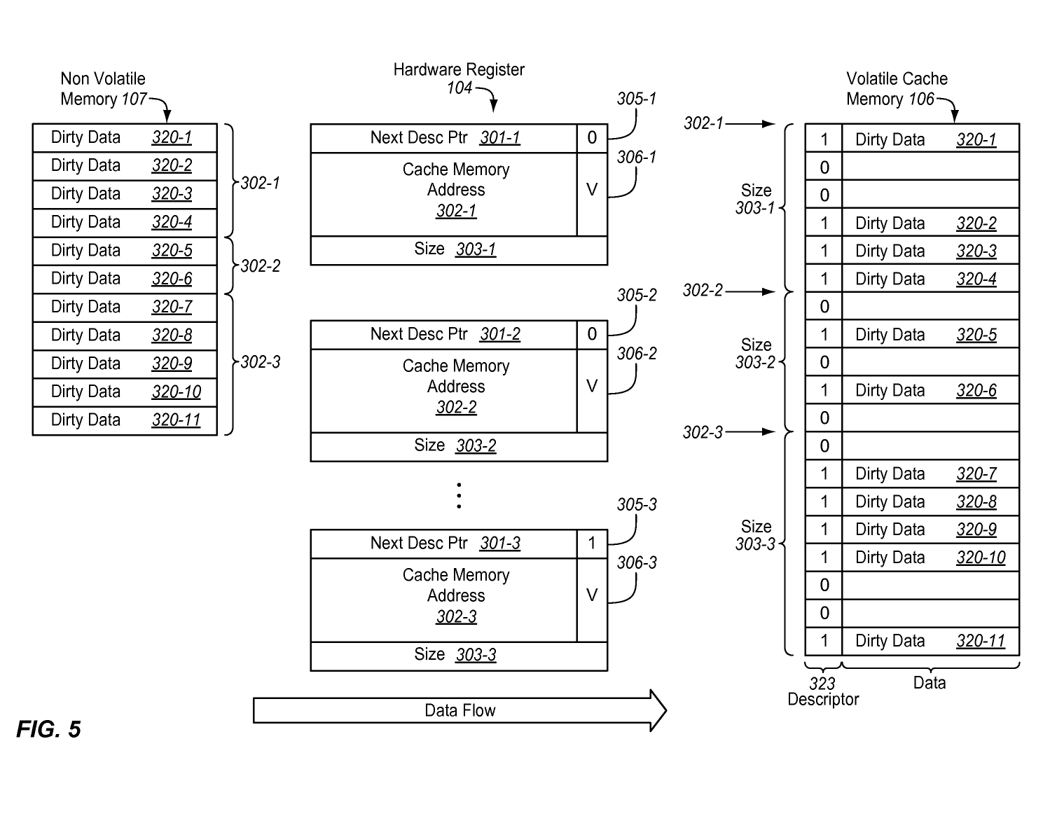

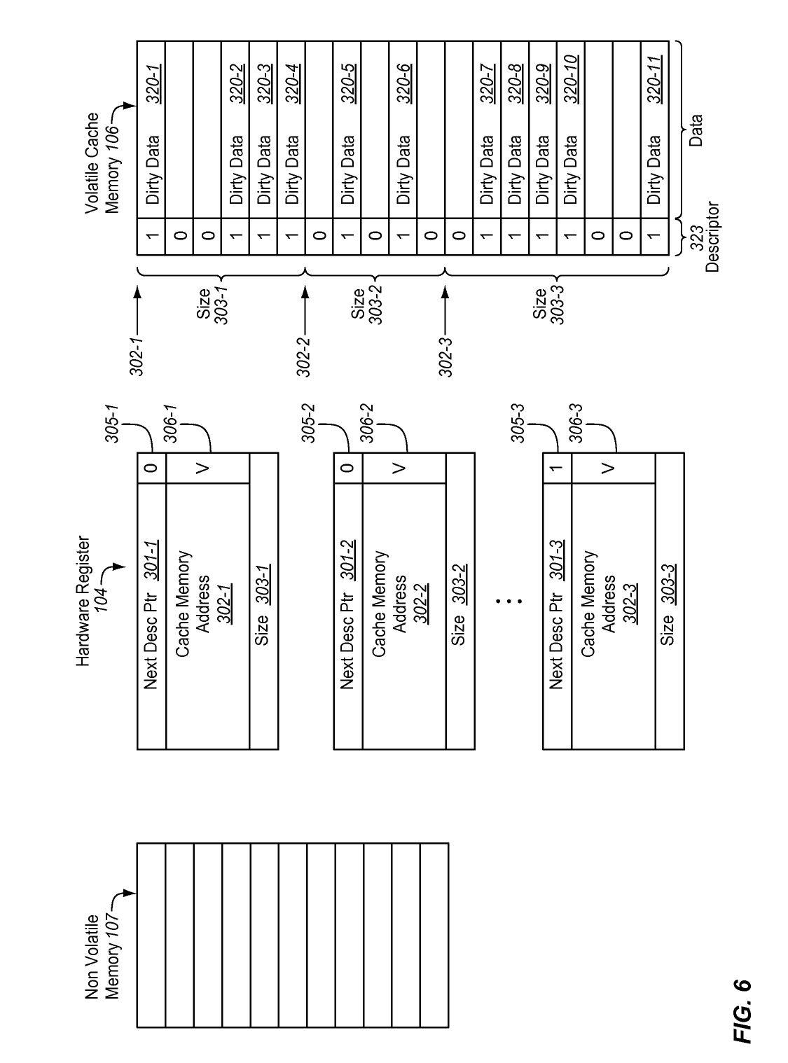

FIGS. 3-6 are block diagrams of data transfers between the volatile cache memory 106, the hardware register 104 of the storage controller 102, and the nonvolatile memory 107. More specifically, FIG. 3 illustrates a DMA of dirty data 320 to the hardware register 104 of the storage controller 102 and then to the nonvolatile memory 107. FIG. 4 illustrates the invalidation of data in the hardware register 104 after the dirty data 320 has been written to the nonvolatile memory 107. FIG. 5 illustrates the DMA of the dirty data 320 to the hardware register 104 and the writing of that dirty data 320 to the cache memory 106 after power is restored. FIG. 6 illustrates the nonvolatile memory 107 being erased once the dirty data 320 is written to the volatile cache memory 106.

Returning to FIG. 3, when the controller 102 writes the write I/O operations and the data thereof to the cache memory 106 as part of its write-back cache operations, the dirty data 320 is flagged with a descriptor 323 (e.g., a logical “1”) to show exactly which data needs to be saved in the nonvolatile memory 107 in the event of a power failure. Unnecessary data, or “clean data” 321, may be flagged with the descriptor 323 (e.g., a logical “0”) in the volatile cache memory 106 to prevent it from being transferred to the nonvolatile memory 107 upon power failure.

The hardware register 104 is configured with firmware pointers 301 that are used to directly access the cache memory 106 and perform DMAs therefrom. Each pointer 301 includes memory addresses 302 that link to the memory addresses in the cache memory 106. For example, the descriptors 323 allow the processor 103 to distinguish the dirty data 320 from the clean data 321. The pointer 301-1 allows the processor 103 to DMA the dirty data segments 320-1, 320-2, 320-3, and 320-4 from the address 302-1 based on the size description 303-1 all of the data at the address 302-1.

A pointer description flag 305 allows the hardware register 104 to know the last amount of data that the processor 103 needs to access from the volatile cache memory 106. For example, the pointers 301-1 and 301-2 are flagged with a pointer description flag 305-1 and 305-2, respectively, that indicate these pointers are not linked to the last amount of data in the cache memory 106. The pointer 301-3 is flagged with a pointer description flag 305-3 of a logical “1” that indicates that it is the last pointer to the data requiring DMA to the nonvolatile memory 107. Upon power failure, the processor 103 uses the pointers 301 of the hardware register 104 to DMA the flagged dirty data 320 and write the dirty data 320 to the nonvolatile memory 107.

During normal operations, the dirty data 320 is flushed to the storage volumes 110, so the processor 103 updates the locations after each data flush. The data may be written to the nonvolatile memory 107 in a manner that allows the hardware register 104 to quickly retrieve the data from the nonvolatile memory 107 when power is restored. For example, the dirty data 320 may be written in the order of the pointers 301 as it was accessed from the cache memory 106.

Once the data is written to the nonvolatile memory 107, any data residing in the hardware register 104 is invalidated, as illustrated in FIG. 4. For example, each of the pointers 301-1-301-3 may be configured with validation tags 306-1-306-3, respectively. Once the processor 103 writes the dirty data 320 from the pointers 301-1-301-3 to the nonvolatile memory 107, the processor 103 flags the data of the pointers 301-1-301-3 of the hardware register 104 as being “not valid” in the respective validation tags 306-1-306-3. This prevents the processor 103 from using any dirty data 320 in the hardware register 104 in the event that power is restored or if the controller 102 is relying on the alternative power supply 109, thereby ensuring the integrity of the dirty data 320 residing in the nonvolatile memory 307.

FIG. 5, again, shows the dirty data 320 being transferred from the nonvolatile memory 107 to the volatile cache memory 106. As the dirty data 320 was transferred to the nonvolatile memory 107 according to the pointers 301-1-301-3 of the hardware register 104, the pointers 301-1-301-3 can be used to DMA the data from the nonvolatile memory 107 and quickly write the dirty data 320 to its previous location in the volatile cache memory 106. Once all of the dirty data 320 from the nonvolatile memory 107 has been written to its appropriate locations in the volatile cache memory 106, the processor 103 may tag the dirty data 320 as being valid via the validation tags 306-1-306-3. For example, the cache memory 106 may acknowledge that all of the dirty data 320 has been written to its appropriate location and that the hardware register 104 can validate the dirty data 320 and resume I/O operations from the cache memory 106. Once this process is complete, the processor 103 erases the nonvolatile memory 107 such that the nonvolatile memory 107 can be used once again in the event of a subsequent power failure, as shown in FIG. 6.

What is claimed is:

1. A system, comprising:
a controller operable to process input/output requests from a host system;
a cache memory operable to cache dirty data pertaining to the input/output requests; and
a nonvolatile memory operable to back up the dirty data during a power outage,
wherein the controller comprises a hardware register operable to map directly to the cache memory to track the dirty data,
wherein the controller is further operable to detect the power outage, and, based on the detected power outage, to direct the hardware register to perform a direct memory access of the dirty data in the cache memory according to the mapping between the hardware register and the cache memory, and to write the dirty data to the nonvolatile memory.

2. The system of claim 1, wherein:
the controller is further operable to detect power being restored, and, based on the detected power restoration, to direct the hardware register to perform a direct memory access of the dirty data from the nonvolatile memory, and to direct the hardware register to write the dirty data to the cache memory until the dirty data can be written to long-term storage.

3. The system of claim 2, wherein:
the controller is further operable to erase the nonvolatile memory after the dirty data is written to the cache memory.

4. The system of claim 1, wherein:
the controller is further operable to detect the power outage through an interrupt request, wherein the interrupt request triggers the direct memory access of the dirty data from the cache memory to the hardware register.

5. The system of claim 1, wherein:
the controller is a Redundant Array of Independent Disks controller in a Redundant Array of Independent Disks storage system.

6. The system of claim 1, wherein:
the cache memory is a double data rate memory.

7. The system of claim 1, wherein:
the controller is further operable to detect an alternative power supply, and to operate only the hardware register during the direct memory access of the dirty data in the cache memory and writing of the dirty data to the nonvolatile memory to conserve power.

8. A method operable within a storage controller, the method comprising:
processing input/output requests from a host system;
caching dirty data pertaining to the input/output requests in volatile cache memory;
detecting a power outage;
performing a direct memory access of the dirty data from the volatile cache memory to a hardware register of the storage controller in response to detecting the power outage; and
writing the dirty data to nonvolatile memory to preserve the dirty data until power can be restored.

9. The method of claim 8, further comprising:
detecting the power being restored;
directing the hardware register to perform a direct memory access of the dirty data from the nonvolatile memory; and
directing hardware register to write the dirty data to the cache memory until the dirty data can be written to long-term storage.

10. The method of claim 8, further comprising:
erasing the nonvolatile memory after the dirty data is written to the cache memory.

11. The method of claim 8, wherein:
detecting the power outage comprises detecting the power outage through an interrupt request, wherein the interrupt request triggers the direct memory access of the dirty data from the cache memory to the hardware register.

12. The method of claim 8, wherein:
the controller is a Redundant Array of Independent Disks controller in a Redundant Array of Independent Disks storage system.

13. The method of claim 8, wherein:
the cache memory is a double data rate memory.

14. The method of claim 8, further comprising:
detecting an alternative power supply; and
operating only the hardware register during the direct memory access of the dirty data in the cache memory and writing of the dirty data to the nonvolatile memory to conserve power.
